(19) United States
(12) Patent Application Publication
(10) Pub. No.: US 2009/0176048 A1
(43) Pub. Date: Jul. 9, 2009

(54) AgSb recording thin film for the inorganic write-once optical disc and the manufacturing method

(75) Inventors: Po-Cheng Kuo, Taipei (TW); Yen-Hsiang Fang, Taipei (TW); Po-Wei Chen, Taipei (TW); Wei-Chih Hsu, Taipei (TW); Don-Yau Chiang, Taipei (TW); Wei-Tai Tang, Taipei (TW); Shih-Hsien Ma, Taipei (TW)

Correspondence Address: BACON & THOMAS, PLLC, 625 SLATERS LANE, FOURTH FLOOR, ALEXANDRIA, VA, 22314-1176, US

(73) Assignee: CMC Magnetics Corporation, Taipei (TW)

(21) Appl. No.: 12/081,058

(22) Filed: Apr. 10, 2008

(30) Foreign Application Priority Data
Jan. 9, 2008 (TW) 097100768

(51) Int. Cl. B32B 3/02

(52) U.S. Cl. 428/64.7; 428/64.4; 428/65.1

(57) ABSTRACT

A recording material of Ag1-xSbx (x=10.8˜25.5 at. %) films for WORM optical disk recording media is invented. The thermal analysis shows that the phase change temperature of AgSb film is between 250 and 270□. The optical property analysis shows that all the as deposited films have good optical absorption and high reflectivity. The X-ray Diffraction analysis shows that the as deposited film and the annealed film are kept at ∈′-AgSb crystalline phase. The TEM analysis shows that the grain size of the Ag80.9Sb19.1 film will grow after annealing. The dynamic test shows that the carrier-to-noise ratio (CNR) of the Ag80.9Sb19.1 optical disc is about 45 dB with λ=657 nm, NA=0.65 and a linear velocity of 3.5 m/s. These Ag₁₋ₓSbₓ films have good optical absorption, high reflectivity and good carrier-to-noise ratio. It can be used as the WORM optical disk recording film.

### FIELD OF THE INVENTION

This invention includes the method for producing Ag₁₋ₓSbₓ thin films with high reflectivity, high absorption and high transmission that can be used as Write Once and Read Many (WORM) optical disk recording film.

### DESCRIPTION OF THE PRIOR ART

Currently, the material used as the recording layer of WORM optical disks is organic dye including anthraaquinone [symbol] cyanine [symbol] indolizium and phthalocyanine (R. T. Young, D. Strand, J. Gonzalez-Hernadez, and S. R. Ovshinsky, Appl. Phys. Vol. 60, p. 4319, 1986; Y. Maeda, H. Andoh, I. Ikuta, and H. Minemura, J. Appl. Phys. Vol. 64, p. 1715, 1988; M. Takenaga, N. Yamada, M. K. Nishiuchi, N. Akira, T. Ohta, S. Nakamura, and T. Yamashita, J. Appl. Phys. Vol. 54, p. 5376, 1983). The advantages of the organic dye are non-oxidation, low phase transmission temperature, high recording sensitivity and low cost. However, the disadvantages of the organic dye is as following:
1. It will cause large jitter values and distortion of disks due to poor conductivity.
2. It will cause poor durability due to low phase transmission temperature.
3 It will cause poor visible light absorption due to the short wavelength range absorption.
4. It will cause poor yield due to non-uniform coating for higher recording density PC substrate.
5. It will cause environment pollution due to organic solvent.

In order to improve the disadvantages of currently used organic dye with short range wavelength absorbed and non-uniform coating, the long range wavelength absorbed inorganic AgSb thin films are invented.

### SUMMARY OF THE INVENTION

The objective of present invention is to fabricate an inorganic AgSb thin film with high reflectivity, high absorption and high crystallization rate that can be used in WORM optical disk.

The optical information recording medium in the present invention can record data using a laser beam from the substrate side. It also can record data using a laser beam from the opposite side of the substrate by adjusting the film structure of the medium. More specifically, as shown in FIG. 1, the optical information recording medium in the present invention is comprised of a first dielectric layer 2, a recording layer 3, a second dielectric layer 4, a reflective layer 5, and a light transmitting layer 6, sequentially deposited on the substrate 1 in the mentioned order.

The substrate 1 is in the form of disc with grooves and lands on the surface. The grooves and lands function as guide tracks for recording and reproducing data. The substrate 1 is comprised of a material including, but not limited to, a glass, a polycarbonate, a silicone resin, a polystyrene resin, a polypropylene resin, a acrylic resin, polymethyl methacrylate, and ceramic materials.

The reflective layer 5 reflects the laser beam L irradiated thereon via the substrate 1 when record data is reproduced, and is made of any of metal materials, such as Al, Ag, Au, Ta, Ni, Ti, Mo, and an alloy of the foregoing metals. The thickness of the reflective layer 5 is in the range of 3 nm to 200 nm.

The first dielectric layer 2 and the second dielectric layer 4 are formed such that they sandwich the recording layer 4. The dielectric layers prevent degradation of record data, and at the same time prevent thermal deformations of the substrate 1 and the light transmission layer 6 during recording of record data. Further, the dielectric layers also increase the amount of change in the optical characteristics between recorded portions and unrecorded portions by the effect of multi-layer interference. The first dielectric layer 2 and the second dielectric layer 4 is formed on the substrate 1 and is comprised of a material including zinc sulfidesulfur dioxide (ZnS—SiO₂), silicon nitride (SiNₓ), germanium nitride (GeNₓ), and silicon carbide (SiC). The thickness of the first dielectric layer 2 and the second dielectric layer 4 are in the range of 1 nm to 300 nm, respectively. Further, one or both of the first dielectric layer 2 and the second dielectric layer 4 can be configured to have a multilayer structure formed by a plurality of dielectric layers.

The recording layer 3 has optical characteristics thereof changed by the laser beam L irradiated thereto during recording of record data so as to be formed with recorded portions. The recording layer 3 is made of a material containing Ag as the main component. In order to form a high reflection and high crystalline speed recording layer, a small amount of Sb are doped into Ag film to formed Ag₁₋ₓSbₓ alloy thin films. In the embodiment of the present invention, the atomic percentage of Sb to the whole material for forming Ag₁₋ₓSbₓ alloy thin films is in the range of 10% to 26%.

The light transmission layer 6 is formed of a resin material, such as a ultraviolet-curing resin or an electron beam-curing resin, such that it has a thickness not less than 1 μm and not more than 150 μm.

The present invention takes the conventional problems described above into consideration, with an object of providing a high-speed, write-once type optical recording medium, an optical recording method and optical recording apparatus with good long term storage reliability and good reproductive durability, which utilizes an inorganic AgSb thin films as recording layer, and is suitable for high-speed, write-once type optical recording using a short wavelength laser light that is either blue or an even shorter wavelength.

### BRIEF DESCRIPTION OF THE DRAWINGS

The present invention will be described in detail with reference to the accompany drawings, in which

FIG. 1. is the cross-section view showing the construction of an optical recording medium according to an embodiment of the present invention.

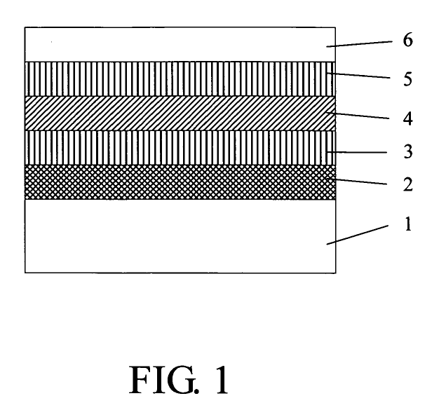

FIG. 2. is the variation of reflectivity with temperature of the as-deposited Ag₁₋ₓSbₓ films.

FIG. 3. is the relationship between the absorption and the Sb content of the as-deposited Ag₁₋ₓSbₓ film at various laser beam wavelengths.

FIG. 4. is the relationship between the absorption decrease and the Sb content of the Ag₁₋ₓSbₓ film at various laser beam wavelengths. The film is annealed at 300° C.

FIG. 5. is the relationship between the absorption decrease and the Sb content of the Ag₁₋ₓSbₓ film at various laser beam wavelengths. The film is annealed at 350° C.

FIG. 6. is the relationships among reflectivity, contrast, and laser beam wavelength of the as-deposited and 300° C. annealed Ag_{80.9}Sb_{19.1} films.

FIG. 7. is the relationship among reflectivity, contrast, and laser beam wavelength of the as-deposited and 350° C. annealed Ag_{80.9}Sb_{19.1} films.

FIG. 8. is the x-ray diffraction patterns of various as-deposited Ag₁₋ₓSbₓ films.

FIG. 9. is the TEM bright field image and diffraction pattern of the as-deposited Ag_{80.9}Sb_{19.1} film.

FIG. 10. is the TEM bright field image and diffraction pattern of the 300° C. annealed Ag_{80.9}Sb_{19.1} film.

FIG. 11. is the TEM bright field image and diffraction pattern of the 350° C. annealed Ag_{80.9}Sb_{19.1}, film.

FIG. 12. is the relationship between the writing power and carrier to noise ratio (CNR) of the Ag_{80.9}Sb_{19.1}, film.

### DETAILED DESCRIPTION OF THE PREFERRED EMBODIMENT

The invention will now be described in detail with reference to the accompanying drawings.

An ZnS—SiO₂ protecting layer with a thickness of 1000 Å was deposited by radio frequency (rf) magnetron sputtering on substrate, naturally oxidized Si (100) wafer and MARIENFELD cover glass. Then Ag₁₋ₓSbₓ recording films (x=10˜26 at. %) with thickness of 1000 Å were deposited on the protecting layer ZnS—SiO₂ by rf co-sputtering of Ag and Sb targets. At last, an Ag (1000 Å) reflecting layer was deposited on the Ag₁₋ₓSbₓ layer by rf magnetron sputtering with an Ar pressure of 3 mTorr. After deposition, the films were annealed at various temperatures in vacuum for 5.5 minutes and then quenched in ice water. The crystal structures of the films were investigated by X-ray diffraction (XRD) with CuKa radiation and a field emission gun transmission electron microscopy (FEG-TEM). Composition of the film was determined from the energy dispersive spectrum (EDS). The thickness of the film was measured by atomic force microscope (AFM). Dynamic tests of disks were carried on a PULSTEC DDU-1000 machine.

Table 1 lists the sputtering parameters for the preparation of Ag₁₋ₓSbₓ thin films. Base pressure of the sputter chamber was approximately 2×10⁻⁷ Torr and films were deposited under an argon pressure P_{Ar} between 2 and 12 mTorr. In order to get higher optical properties, P_{Ar}=3 mTorr is preferred.

### Example 1

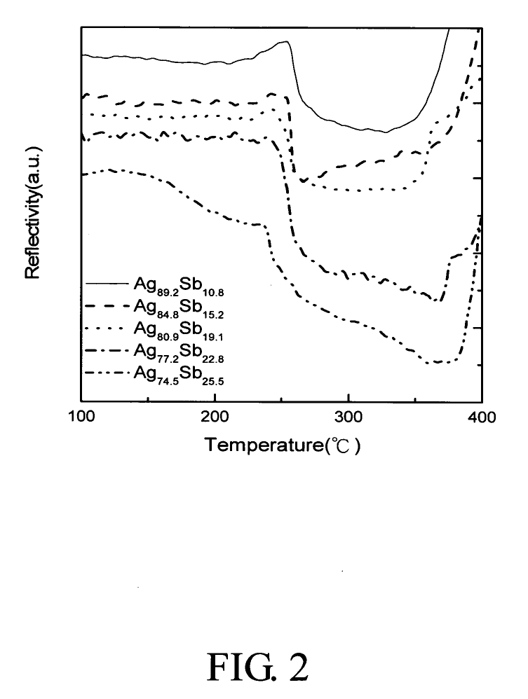

The initial substrate temperature was at room temperature. After the sputtering chamber was evaluated to 2×10⁻⁷ Torr, Ar gas was introduced into the chamber. The Ar pressure was maintained at 3 mTorr during the entire sputtering period. The sputtering conditions for producing an multi-layer films, which is comprised of a ZnS—SiO₂ dielectric layer, a AgSb recording layer, and a Ag reflective layer, sequentially deposited on a substrate in the mentioned order were shown in Table 1.
FIG. 2 shows the relationship between reflectivity and temperature of the as-deposited Ag₁₋ₓSbₓ films at a heating rate of 50° C./min. Two reflectivity changes are clearly observed in all the films as the temperature is increased from 100 to 400° C.

It indicates that the first phase transition temperature of Ag₁₋ₓSbₓ films is around 250° C. Moreover, a higher reflectivity is observed when the Sb content of the film is lower than 19.1 at. %. But, the films with Sb content lower than 19.1 at. % have lower contrast around 250° C. than those of Sb content higher than 19.1 at. %. However, when the temperature is lower or higher the phase transition temperature, only the reflectivity of Ag_{80.9}Sb_{19.1} film is stable.

### Example 2

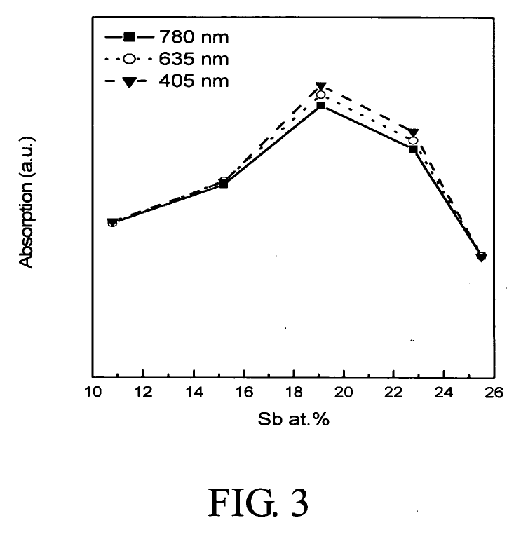

FIG. 3 shows the relationship between the absorption and the Sb content of the as-deposited Ag₁₋ₓSbₓ film at various laser beam wavelengths. It is found that the absorption of Ag₁₋ₓSbₓ film increases as the Sb contents increase from 10.8 at. % to 19.1 at. % for the laser wavelengths of 405, 635 and 780 nm. As the Sb content is 19.1 at. %, the Ag₁₋ₓSbₓ film has the highest absorption for all laser wavelengths.

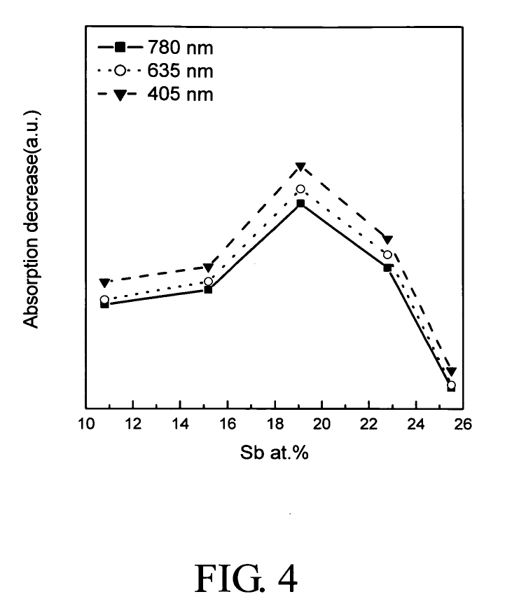

FIG. 4. shows the relationship between the absorption and the Sb content of the Ag₁₋ₓSbₓ film which annealed at 300° C. For the wavelengths of 405, 635 and 780 nm, it is found that when the Sb content is smaller than 19.1 at. %, the absorption decrease of Ag₁₋ₓSbₓ film increases as the Sb content is increased. Moreover, the maximum value of absorption decrease of the Ag₁₋ₓSbₓ film is occurred at Sb content of Sb ˜19.1 at. %. When the Sb content is larger than 19.1 at. %, the absorption decrease of Ag₁₋ₓSbₓ film decreases as the Sb content increases.

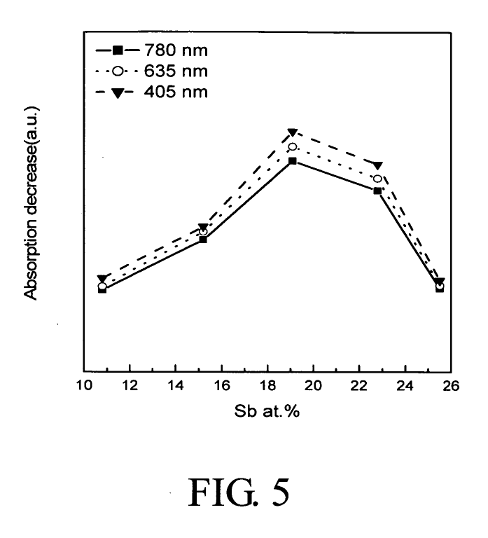

FIG. 5. shows the relationship between the absorption and the Sb content of the Ag₁₋ₓSbₓ film which annealed at 300° C. For the wavelengths of 405, 635 and 780 nm, it is found that when the Sb content is smaller than 19.1 at. %, the absorption decrease of Ag₁₋ₓSbₓ film increases as the Sb content is increased. The maximum value of absorption decrease of the Ag₁₋ₓSbₓ film is occurred at Sb ˜19.1 at. %. When the Sb content is larger than 19.1 at. %, the absorption decrease of Ag₁₋ₓSbₓ film decreases as the Sb contents increases.

In view of the above results, Ag_{80.9}Sb_{19.1} films have good absorption at the wavelength of 405 nm (Blue-ray Disc), 635 nm (DVD) and 780 nm (CD).

### Example 3

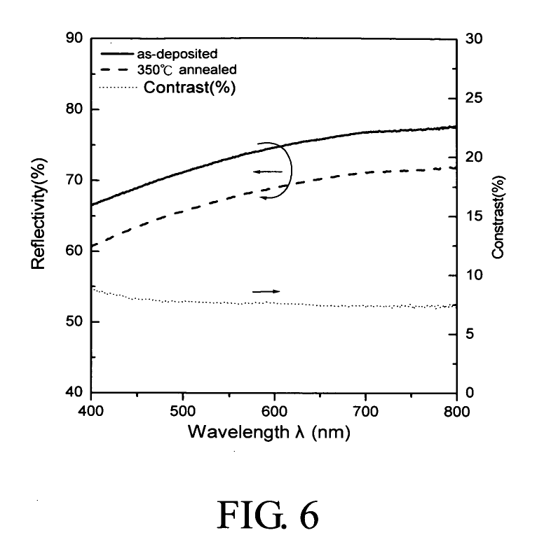

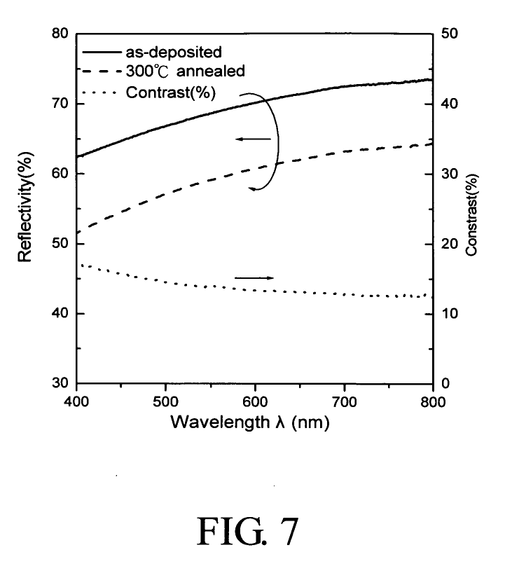

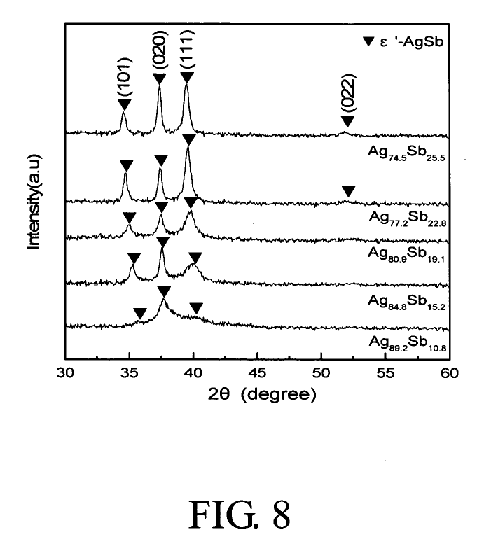

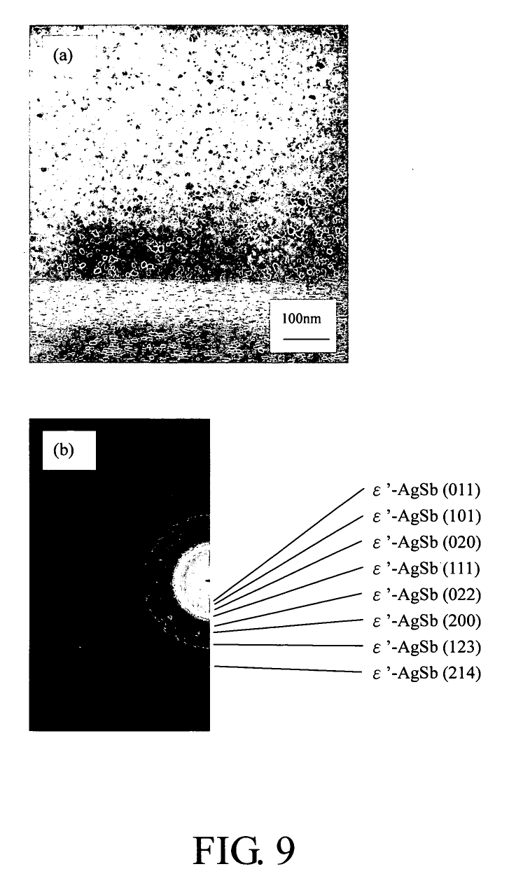

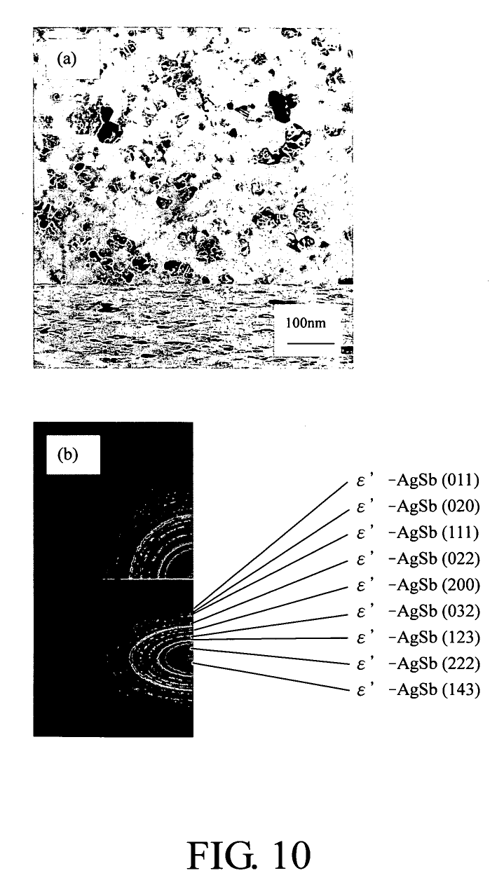

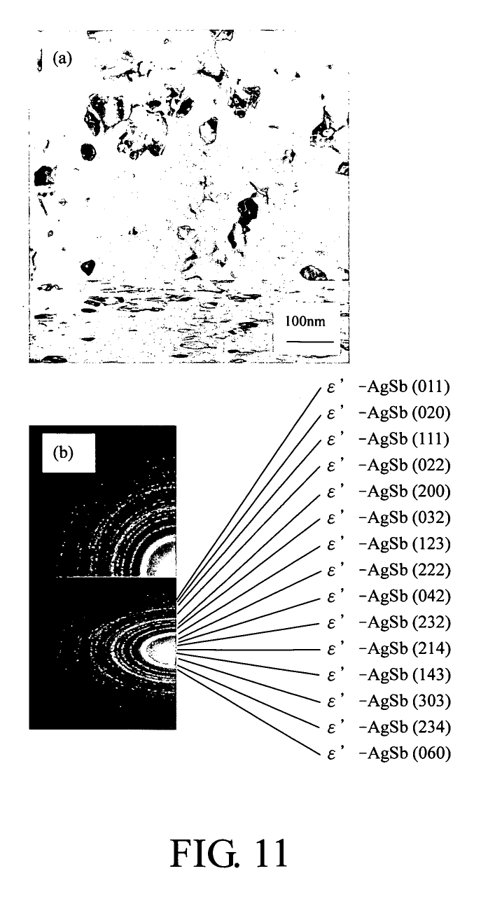

FIG. 6 and FIG. 7 show the reflectivity and contrast of the as-deposited and annealed Ag_{80.9}Sb_{19.1} films at various laser beam wavelengths, and annealing temperatures 300° C. and 350° C., respectively. The reflectivity of the Ag_{80.9}Sb_{19.1} film is decreased after annealing at 300° C. or 350° C. From the X-ray diffraction pattern (FIG. 8), we observed that the as-deposited Ag_{80.9}Sb_{19.1} film has orthorhombic ∈′-AgSb crystalline structure. The orthorhombic structure is the cause of the optical anisotropy. By grain refining, the optical anisotropy could be reduced to avoid the difference of reflection from different grain orientation. FIG. 9, FIG. 10 and FIG. 11 show the TEM images and electron diffraction patterns of the as-deposited, annealed at 300° C. and 350° C. Ag_{80.9}Sb_{19.1} films, respectively.

From FIG. 9, it is found that the grain sizes are about 5-10 nm and the grains are uniform for the as-deposited film. The optical anisotropy is reduced due to this small and uniform grain size which leads to the large reflectivity of the as-deposited Ag_{80.9}Sb_{19.1} film as shown in FIGS. 6 and 7. After the Ag_{80.9}Sb_{19.1} films are annealed at 300 or 350° C., the grain size grow to 10-100 nm. These non-uniform grain sizes would cause more optical anisotropy and lead to a reduction in the reflectivity of the film. Therefore, the reflectivity of the Ag_{80.9}Sb_{19.1} film after annealing at 300 or 350° C. would be lower than the as-deposited film, as shown in FIGS. 6 and 7. The contrasts of the Ag_{80.9}Sb_{19.1} films are about 12.5117% and 11-12% in the wavelength between 400 nm and 800 nm for the films annealed at 300° C. and 350° C., respectively.

### Example 4

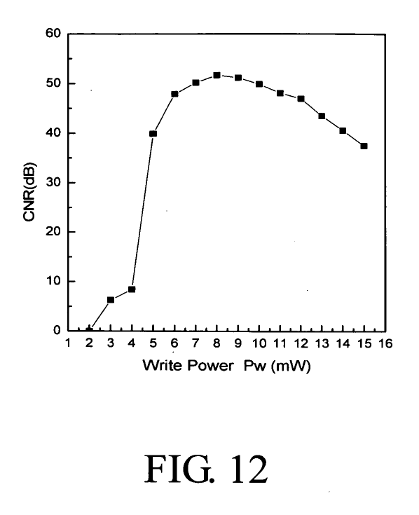

Since the Ag_{80.9}Sb_{19.1} film has higher reflectivity, higher optical contrast, and suitable phase transition temperature, we take the Ag_{80.9}Sb_{19.1} disc for dynamic tests. The dynamic test was conducted at λ=657 nm, Numerical Aperture (NA)=0.65, DVD 1X and 14 T. FIG. 12 shows the relationship between the writing power and carrier-to-noise ratio (CNR). The critical writing power is about 3 mW. A small recording area is formed when the writing power is smaller than 4 mW. This leads to small CNR values (less than 10 dB). If the writing power is in the range of 6˜12 mW, the CNR values are higher than 45 dB due to larger recording area. This is quite satisfactory for the requirements of the WORM optical disk. The CNR value decreases as the writing power is higher than 12 mW may be due to the distortion of the film structure of the disk at higher writing power. The distortion of film structure of the disk will increase the noise.

TABLE 1

| Substrate temperature (Ts) | Ambient temperature |
|---|---|
| RF power density | 1~5 W/in² for ZnS—SiO₂ target |
| RF power density | 1~5 W/in² for Ag target |
| RF power density | 1~0.3 W/in² for Sb target |
| Base vacuum | 2 × 10⁻⁷ Torr |
| Distance between substrate and target | 12 cm |
| Argon pressure | 2~12 mTorr |

What is claimed is:

1. An optical recording medium comprising a substrate, a reflective layer, a dielectric layer, a recording layer and a light transmission layer. The recording layer using Ag₁₋ₓSbₓ thin films and the atomic percentage of Sb is in the range of 10% to 26%.

2. An optical recording medium according to claim 1, which further comprises a first dielectric layer and a second dielectric layer on opposite sides of the recording layer.

3. An optical recording medium according to claim 1, wherein a thickness of the recording layer is in the range of 3 nm˜200 nm.

4. An optical recording medium according to claim 1,
wherein the first dielectric layer and the second dielectric layer are made of a material selected from the group consisting of silicon nitride (SiNₓ), zinc sulfide-sulfur dioxide (ZnS—SiO₂), silicon carbide (SiC), and germanium nitride (GeNx).

5. An optical recording medium according to claim 1, wherein a thickness of the first dielectric layer and the second dielectric layer is in the range of 0 nm˜300 nm.

6. An optical recording medium according to claim 5, wherein the first dielectric layer and the second dielectric layer comprise a single dielectric layer or a complex dielectric layer.

7. An optical recording medium according to claim 1, wherein the reflective layer is made of a material selected from the group consisting of Au, Ag, Mo, Al, Ti, Ta, and an alloy of the foregoing metals.

8. An optical recording medium according to claim 1, wherein a thickness of the reflective layer is in the range of 2 nm˜200 nm.

9. An optical recording medium according to claim 1, which further comprises a light transmission layer having a thickness of 1 to 150 μm on the opposite side to the substrate with respect to the recording layer. The light transmission layer is formed of a resin material, such as a ultraviolet-curing resin or an electron beam-curing resin.

10. An optical recording medium according to claim 1, wherein the substrate is in the form of disc with grooves and lands on the surface. The grooves and lands function as guide tracks for recording and reproducing data. The substrate is comprised of a material including, but not limited to, a glass, a polycarbonate, a silicone resin, a polystyrene resin, a polypropylene resin, a acrylic resin, polymethyl methacrylate, and ceramic materials.

11. The method for producing the optical recording medium according to claim 1, includes magnetron co-sputtering of Ag and Sb targets or sputtering a AgSb alloy target at controlled sputtering power and sputtering argon gas pressure to form a selective composition of AgSb alloy thin film.

12. The method of claim 11, wherein the sputtering substrate temperature is in the range between 10 and 90° C.
